(19) United States
(12) Patent Application Publication
(10) Pub. No.: US 2011/0075983 A1
(43) Pub. Date: Mar. 31, 2011

(54) TELECOMMUNICATIONS CABLE INLET DEVICE

(76) Inventors: Kaili Fan, Shanghai (CN); Junsheng Zhou, Shanghai (CN); Zhiyong Xu, Shanghai (CN); Jingwen Zhong, Shanghai (CN)

(21) Appl. No.: 12/994,949

(22) PCT Filed: Jun. 15, 2009
(86) PCT No.: PCT/US09/47351

§ 371 Date: Nov. 29, 2010

(30) Foreign Application Priority Data
Jun. 24, 2008 (CN) 200810128881.X

(51) Int. Cl. G02B 6/00; H02G 3/18

(52) U.S. Cl. 385/135; 174/653

(57) ABSTRACT

An inlet device is described herein for inserting a plurality of telecommunication cables into a telecommunications enclosure. An exemplary inlet device includes a housing, a retention device and a compression member. The housing has a first end and a second end, wherein the housing includes a compressible portion at the second end of the housing and the retention device may be secured to the first end of the housing. The compression member may be fitted over the compressible portion at the second end of the housing and the retention device may be secured to the first end of the housing. The cable retention device includes a rack to discretely hold a plurality of telecommunication cables. The cables may be further secured in the rack of the cable retention device by one or more clamping devices.

### FIELD OF THE INVENTION

The present invention relates to an inlet device for inserting a plurality of telecommunication cables containing optical fibers, copper wires or micro-coax cables into a telecommunication enclosure, e.g. into a terminal closure, pre-stubbed terminal, optical network terminal or other junction box.

### BACKGROUND OF THE INVENTION

Telecommunication cables are ubiquitous and used for distributing data across vast networks. The majority of cables are electrically conductive cables (typically copper), although the use of optical fiber cables is growing rapidly in telecommunication networks as larger and larger amounts of data are transmitted.

As telecommunication cables are routed across data networks, it is necessary to periodically open the cable so that one or more telecommunication lines therein may be spliced, thereby allowing data to be distributed to other cables or “branches” of the telecommunication network. At each point where a telecommunication cable is opened, it is necessary to provide a telecommunication enclosure to protect the exposed interior of the cable. The cable branches may be further distributed until the network reaches individual homes, businesses, offices, and so on.

Many conventional telecommunication enclosures utilize either a mastic or rubber grommets for introducing cables into the enclosure. Some mastic and grommet assemblies can accommodate more than one cable. Alternatively, inlet devices that may be mounted onto the cable prior to installation of the cable in a port of a telecommunication enclosure are also known. However, these inlet devices typically accommodate only one cable per port in the enclosure. Conventional inlet devices are described in U.S. Pat. No. 6,487,344 and U.S. Patent Publication No. 2009/0060421 A1 which can be inserted into a port in the wall of a telecommunication enclosure.

### SUMMARY OF THE INVENTION

An exemplary inlet device is described herein for inserting a plurality telecommunication cables into a port of a telecommunication enclosure. The inlet device includes a housing, a retention device and a compression member. The housing has a first end and a second end, wherein the housing includes a compressible portion at the second end of the housing and the retention device may be secured to the first end of the housing. The compression member may be fitted over the compressible portion at the second end of the housing. The cable retention device includes a rack to discretely hold a plurality of telecommunication cables. The cables may be further secured in the rack of the cable retention device by one or more clamping devices.

In an alternative aspect of an exemplary inlet device, inlet device includes a housing, a retention device, a compression member and a pressure wedge. The housing has a first end and a second end, wherein the housing includes a compressible portion at the second end of the housing and the retention device may be secured to the first end of the housing. The compression member may be fitted over the compressible portion at the second end of the housing. The cable retention device includes a rack to discretely hold a plurality of telecommunication cables. The pressure wedge may be inserted into the rack to further lock the plurality of communication cables into the cable retention device. A clamping member or hook may be used to lock the pressure wedge into the rack of the cable retention device.

The above summary of the present invention is not intended to describe each illustrated embodiment or every implementation of the present invention. The figures and the detailed description that follow more particularly exemplify these embodiments.

### BRIEF DESCRIPTION OF THE DRAWINGS

The present invention will be further described with reference to the accompanying drawings, wherein:

FIG. 1A shows an exploded view of an exemplary inlet device according to an aspect of the present invention;

FIG. 1B shows an partially assembled view of the inlet device of FIG. 1A;

FIG. 1C shows an exploded view of the housing and retention device of FIG. 1A;

FIGS. 2A-F show several alternative aspects of an exemplary retention device;

FIGS. 3A-G show several aspects of an alternative retention device including a pressure wedge according to the present invention;

FIGS. 4A and 4B show another alternative retention device including a pressure wedge according to an aspect of the present invention

FIGS. 5A and 5B show two embodiments of exemplary internal sealing members insertable in an exemplary inlet device according to an aspect of the present invention; and

FIG. 6 shows an isometric view of an alternative housing according to an aspect of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF THE DRAWINGS

In the following detailed description of the preferred embodiments, reference is made to the accompanying drawings, which illustrate specific embodiments in which the invention may be practiced. The illustrated embodiments are not intended to be exhaustive of all embodiments according to the invention. It is to be understood that other embodiments may be utilized and that structural or logical changes may be made without departing from the scope of the present invention. The following detailed description, therefore, is not to be taken in a limiting sense, and the scope of the present invention is defined by the appended claims.

Exemplary embodiments herein provide an inlet device for the insertion of a plurality of telecommunication cables into a telecommunication enclosure, especially a plurality of telecommunication drop cables through a single port of a telecommunication enclosure. The drop cables may be optical fiber cables, a small pair count copper cables or micro-coax cables. Particular advantages of the design of the present inlet device include a low cost, field installable inlet device that provides an environmental seal around a plurality of drop cables. The inventive inlet device has fewer parts than some conventional inlet devices which makes it straight forward to install in the field.

The exemplary inlet device may be fitted to a communication cable and inserted into a port in a telecommunication enclosure to secure the telecommunication cable in the port. Depending on the communication network architecture, the telecommunication enclosure may be a buried closure, an aerial closure or terminal, a fiber distribution hub or an optical network terminal in the outside plant or a wall mount communication box, fiber distribution hub, a wall mount patch panel, or an optical network terminal in premise applications.

In one exemplary embodiment, the telecommunication cable is a fiber optic cable such as a fiber reinforced plastics (FRP) drop cable available from Shenzhen SDG information Co., Ltd. (Shenzhen Guangdong, China). Fiber optic cable typically includes a semi-rigid outer sheath surrounding at least one optical fiber and at least one strength member. The optical fibers may be enclosed in one or more loose buffer tubes or may be provided as one or more optical fiber ribbon cables. Each optical fiber has a polymeric coating that surrounds and protects the glass fiber. Additional examples of exemplary optical fiber cables include ResiLink ADF™ All-Dielectric Flat Drop Cable available from Pirelli Cables and Systems (Columbia, N.C.) or EZ DROP cable from Draka (Claremont, N.C.), and Mini DP Flat Drop Cable available from OFS (Northcross, Ga.). The strength members may be either semi-rigid rods or a collection of loose fibers e.g. made of aramid fibers.

Alternatively, the telecommunication cable may be a low wire count copper cable having a semi-rigid sheath surrounding a plurality of paired copper wires or a copper micro-coax cable.

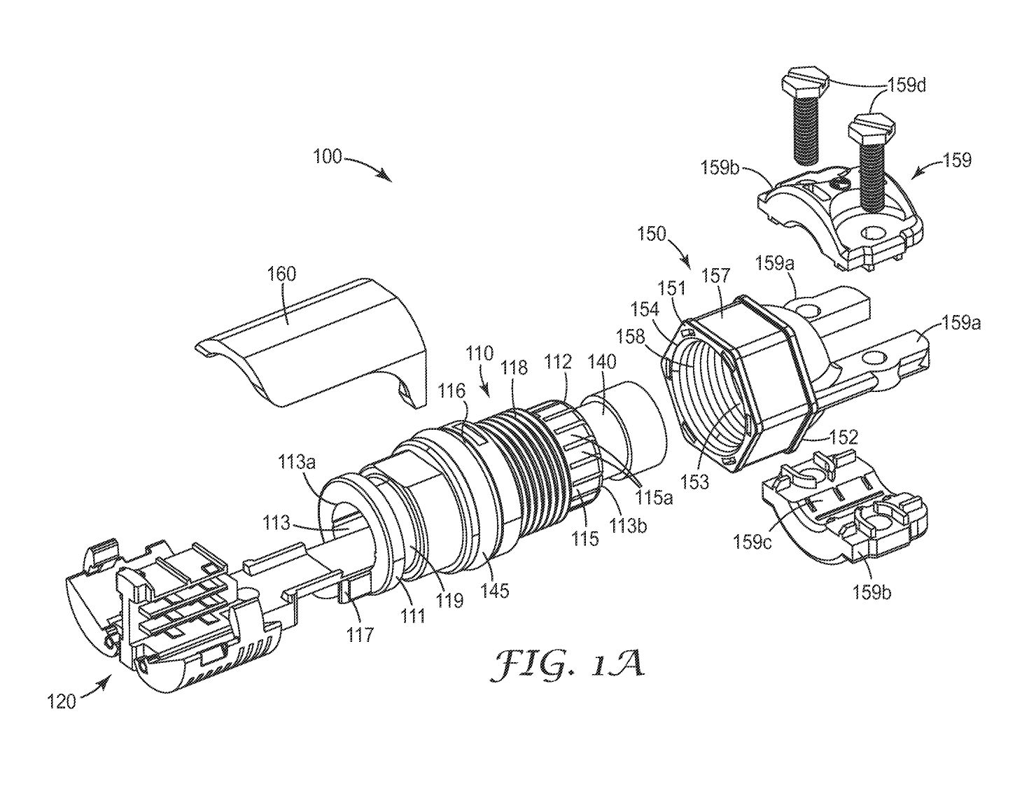

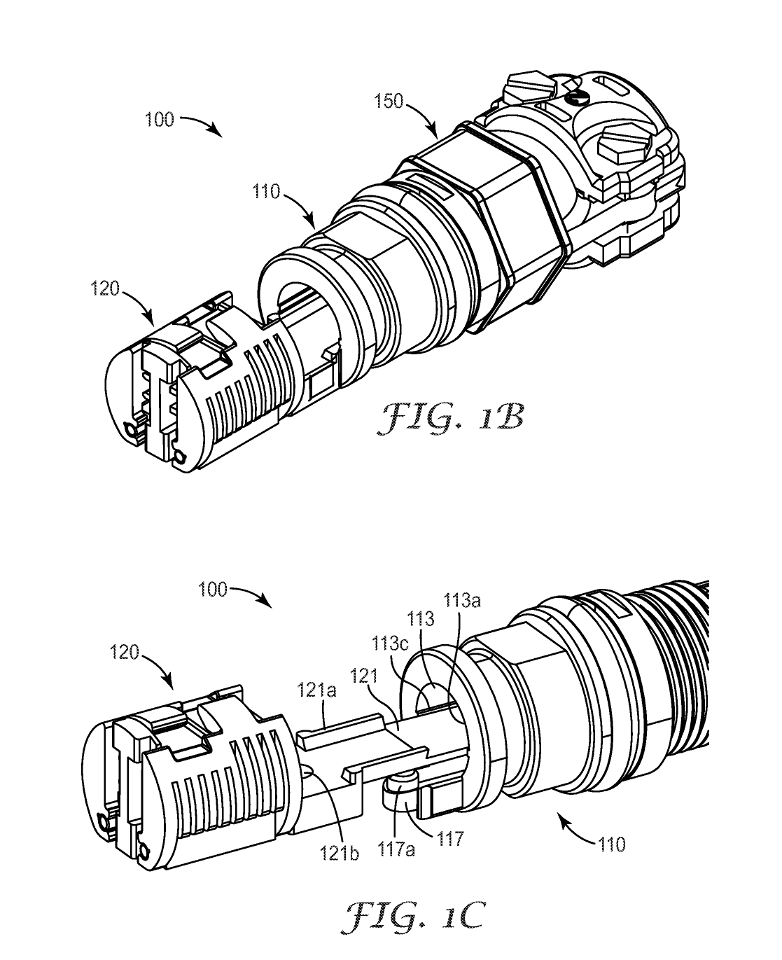

Referring to FIGS. 1A-1C, an exemplary inlet device 100 includes a housing 110 having a first end 111 and a second end 112, an internal sealing member 140 shaped to be received within the second end 112 of the housing, and a compression member attachable to the second end 112 of the housing. The compression member may be a clamping nut 150 or other device capable of applying a radial force to the second end 112 of the inlet device housing 110. The inlet device 100 may be formed of plastic by conventional methods, for example by injection molding.

The housing 110 may be generally cylindrical in shape and includes an interior passageway 113 that extends along the length of the housing from the first end 111 to the second end 112 of the housing. The housing includes a passage entry 113a at the first end 111 of the interior passageway 113 and a passage exit 113b at the second end 112 of the interior passageway 113 that may be configured to accommodate certain categories of telecommunication cables including single fiber drop cables, multi-fiber cables, copper communication cables or micro-coax cables.

The first end of the housing will reside inside the telecommunication enclosure when the inlet device has been fully inserted into a port of a telecommunication enclosure. A locking fork 160 (FIG. 1A) can be inserted into receiving channel 119 on housing 110 of inlet device 100 to secure the inlet device in the port of the telecommunication enclosure. The second end of the housing may be located within the port of the telecommunication enclosure when the inlet device has been fully inserted into a port of a telecommunication enclosure. Alternatively, the second end of the tubular body may extend completely through the port of the telecommunication enclosure.

A groove 116 may be located between the first end 111 and the second end 112 of housing 110 to receive an external sealing member 145 such as an o-ring. This external sealing member 145 can provide an environmental seal between the inlet device 100 and a port of a telecommunication enclosure when the inlet device is fully seated therein.

The housing 110 can have an external threaded portion 118 located between groove 116 and the second end 112 of the housing 110. The external threaded portion 118 cooperates with a corresponding internal threaded portion 158 of a compression member (e.g. clamping nut 150) to cause a compressible portion 115 of the housing 110 to be constricted around the internal sealing member to hold the cables installed therein.

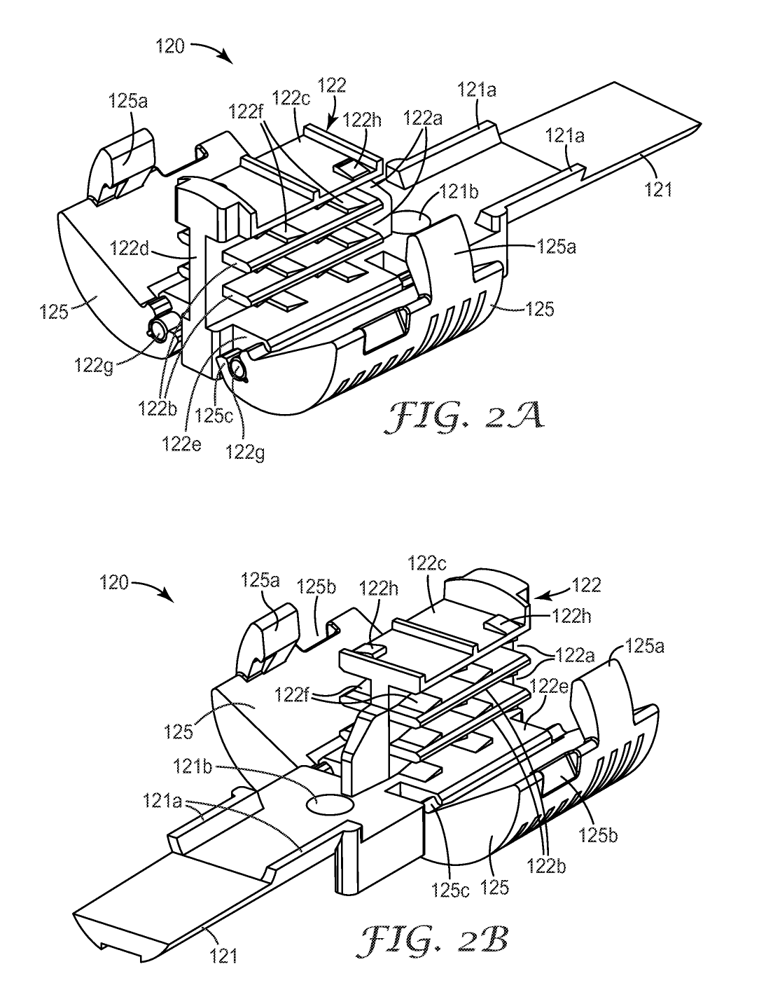

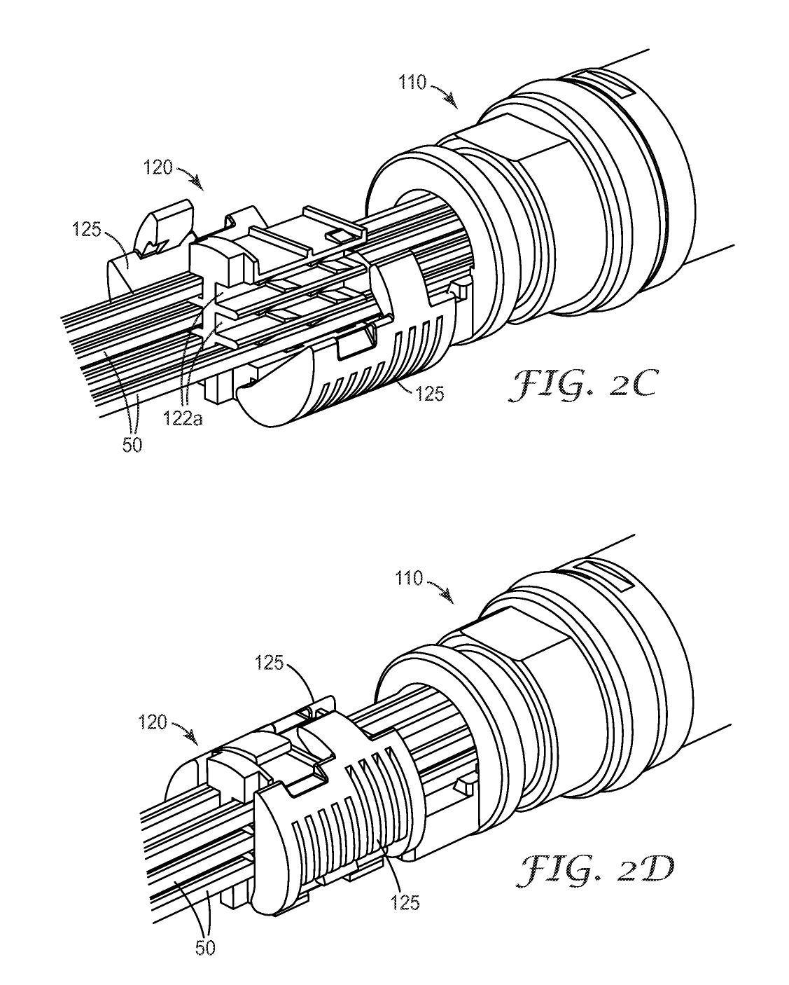

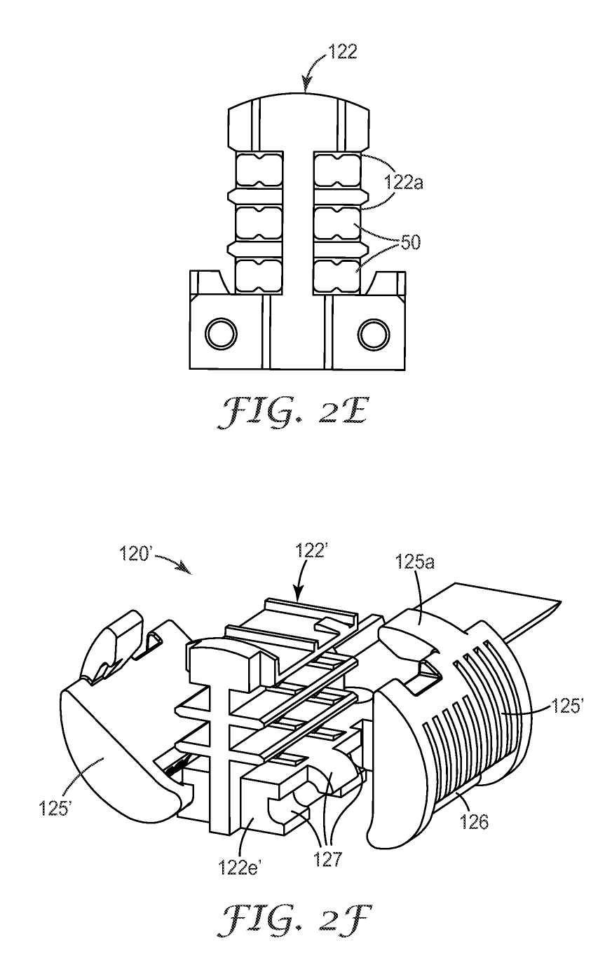

The compressible portion 115 is formed at the second end 112 of the housing 110. The compressible portion 115 may be reduced in size (diameter) when an external radial force is exerted on it such as by application of the clamping nut 150. The compressible portion 115 may include a plurality of spaced apart flexible fingers 115a which surround the passage exit 113b. The fingers 115a may be squeezed together the clamping nut 150 is attached to the second end of the housing 110. An optional internal sealing member 140 may be fitted into the interior passageway 113 in the compressible portion 115 of the housing 110 to improve the sealing capability of the inlet device 100 around a plurality of telecommunication cables as may be needed in buried or other subterranean telecommunication enclosure installations. The telecommunication cables 50 (FIG. 2C) pass through the internal sealing member 140 when the cable is installed into the inlet device 100. The tightening of the clamping nut 150 over the compressible portion 115 of the housing 110 compresses the internal sealing member 140 around the communication cables 50. In some applications such as in premise installations, a lesser degree of environmental protection is required and the internal sealing member 140 may be replaced by a sealing member having a single opening. In this case, all the incoming cables will pass through the single opening of the sealing member and this sealing member may be compressed by the compressible portion of the housing of an exemplary inlet device.

The cable clamping nut 150, shown in FIG. 1A, has an interior chamber 153 extending between the first side 151 and a second side 152 of the clamping nut. The interior chamber 153 has a first opening 154 at the first side 151 to accept the second end 112 of housing 110. The interior chamber 153 has a smaller second opening (not shown) at the second side 152 of the clamping nut 150 to accommodate the passage of a telecommunication cable therethrough. The interior chamber 153 has an internal threaded portion 158 that corresponds to and is engagable with the external threaded portion 118 on the housing 110 to allow the cable clamping nut 150 to be secured to the housing.

In an exemplary embodiment, clamping nut 150 can have a gripping surface 157 on the external surface of the cable clamping nut that corresponds to the position of the internal threaded portion 158. The external gripping surface 157 may be a hexagonally shaped cross-section as shown in FIG. 1A to facilitate gripping of the cable securing device with a tool or by hand. The gripping surface region may have other geometric configurations such as a circular cross-section, a rectangular cross-section or other polygonal cross-section. Additionally, the gripping surface may be textured (e.g. a ridged or cross-hatched texture) to further facilitate gripping of the cable securing device.

Clamping nut 150 includes a retaining clamp 159 disposed on the second side 152 of clamping nut 150 to securely hold one or more telecommunication cables. Two longitudinal side tabs 159a project from the second side 152 of clamping nut 150. Two halves 159b of retaining clamp 159 may be secured to the longitudinal side tabs by conventional mechanical fasteners 159d such as by screws or rivets. The interior surface 159c of the two clamp halves may be concave and have ridges or barbs to bite into the sheath of the telecommunication cables to further securely grip the telecommunications cable when it is installed into an exemplary inlet device. In an alternative embodiment, one of the halves of the retaining clamp may be integrally formed with the longitudinal side tabs to reduce the number of parts required. Alternative forms of cable clamping nuts are described in U.S. Patent Application No. 61/043,652, which is incorporated by reference herein, in its entirety.

A cable retention device 120 may be secured to the first end 111 of the housing 110 such as by the insertion of tongue 121 on the cable retention device 120 into the passage entry 113a of the housing. Tongue 121 may be positioned below guides 113c disposed on the wall of the interior passageway 113 of housing 110. In an exemplary embodiment, guides 113c may be in the form of a pair of longitudinal ridges located on opposing sides of the interior passageway 113 and that extend along a length of the interior passageway. Alternatively, the guides may be in the form of a series of spaced apart bumps located on opposing sides of the interior passageway and that extend along a length of the interior passageway. The guides 113c control the vertical position of the cable retention device 120 in the housing 110. The cable retention device 120 may be slid into the housing 110 until positioning bump 117a on extension 117 of housing engages with a depression or hole 122 on tongue 121 of the cable retention device to fix the horizontal position of the cable retention device 120 in the housing. When fully seated within the housing 110, the ribs 121a disposed on tongue 121 interact with guides 113c to hold the cable retention device 120 in place.

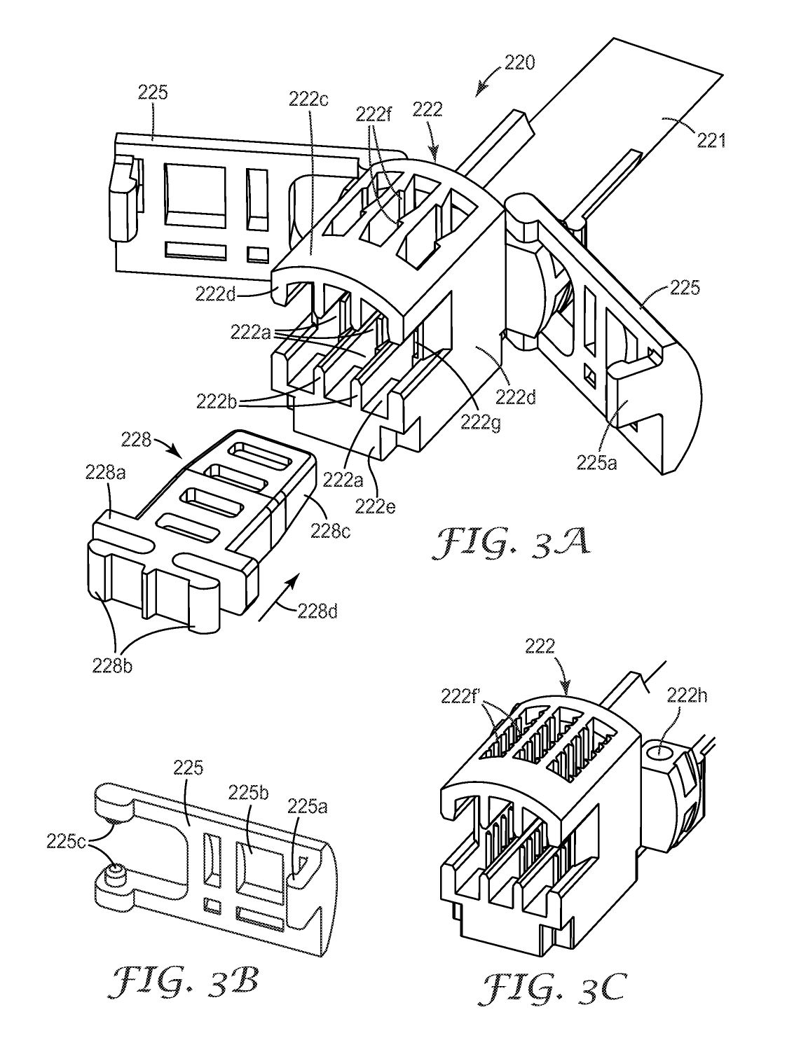

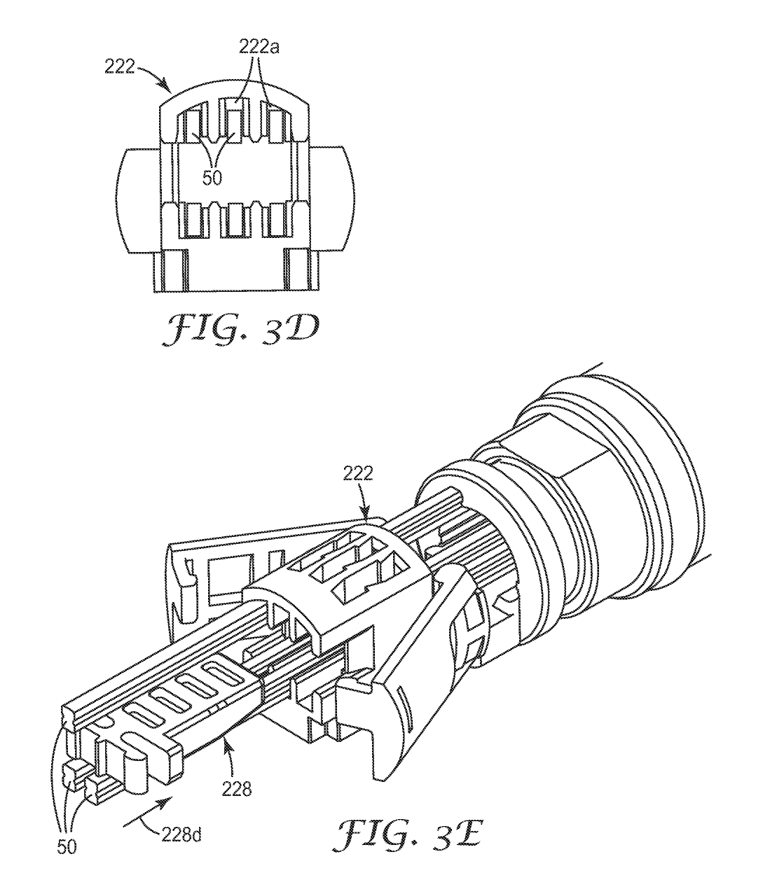

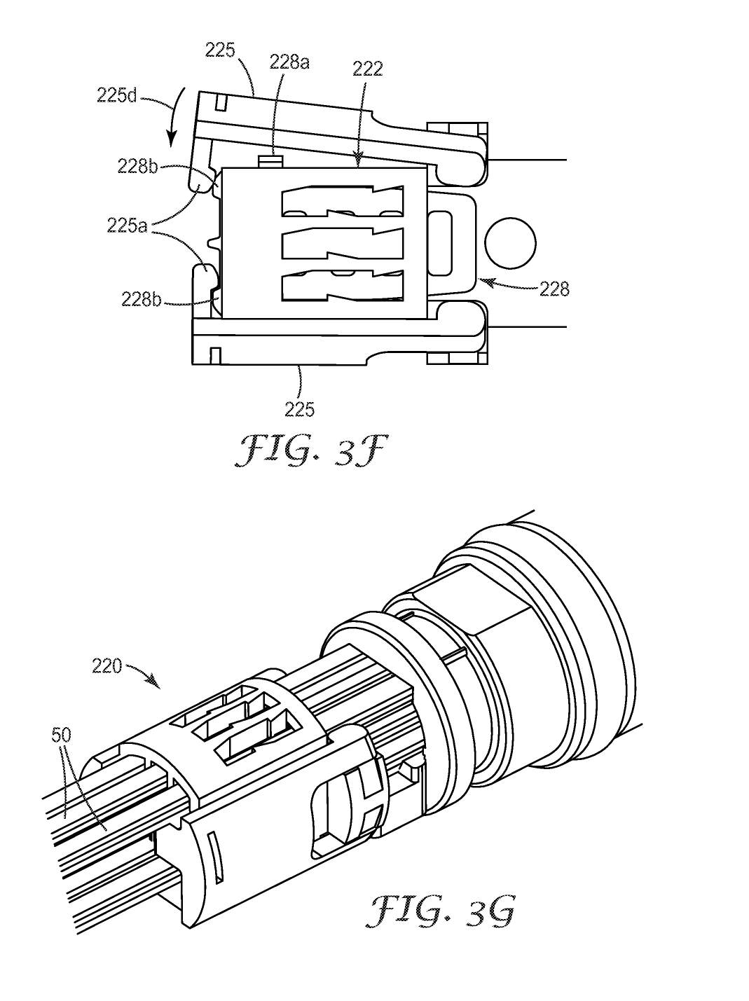

Referring to FIGS. 2A-D, cable retention device 120 includes a rack 122 for securing a plurality of telecommunication cables 50 to the inlet device. In an exemplary embodiment, a plurality of fiber optic drop cables, such as FRP drop cables may be fitted into a corresponding number of compartments 122a within the rack 122 of cable retention device 120. Each compartment 122a may be separated from an adjacent compartment next to it by a central support 122d and from the compartment above or below it by a shelf 122b that extend from the central support 122d. The central support 122d attaches to a base 122e on the bottom end thereof and a top shelf 122c at the top of the central support opposite the base 122e. Each shelf 122b can have a plurality of ridges 222f (FIG. 3C) or teeth 122f located on one or both surfaces of the shelf. The teeth 122f can engage with the outer sheath of the telecommunication cable to hold it firmly within a given compartment against an axial load placed on the cable.

Additionally, the retention device 120 may have at least one clamping member to assist in retaining the cables within the compartments of rack 122. FIG. 2A-2D show a retention device having two clamping members 125 which are hingedly attached to the base 122e of rack 122 through a hinge pin 122g that is integrally formed with the base and at least one C-shaped holder 125c formed on one edge of each clamping members. In the exemplary embodiment shown in FIGS. 2A and 2B, each clamping member has a resilient latch 125a extending from an edge of the clamping member opposite the C-shaped holder 125c. The latch 125a engages with a catch 122h on the top of the top shelf 122c of rack 122.

FIG. 2C shows the installation of telecommunication cables 50 into the cable retention device 120. The telecommunication cable 50 is placed into compartments 122a. Once the desired number of telecommunication cables has been installed on one side of the rack, the clamping member on that side of the rack may be closed. Then the remaining cables may be placed in the other side of the rack and that clamping member closed when they are in place. Advantageously, the clamping members may assist in the final positioning of the telecommunication cables within compartments 122a by pushing the cables fully into each compartment. In one exemplary embodiment, the clamping members may have a ridge or plurality bumps (not shown) extending longitudinally along the clamping member and aligned with each compartment to assist in pushing the telecommunication cables into the compartments. FIG. 2D shows six telecommunication cables 50 installed into the cable retention device 120. FIG. 2E is a cross-section of an exemplary cable retention device 120 showing the proper positioning of the telecommunication cables 50 installed in compartments 122a of rack 122.

FIG. 2F shows an alternative embodiment of a cable retention device 120′ having a different hinging mechanism attaching the clamping members 125f′ to rack 122′. The clamping members 125′ have a rotation shaft 126 extending along an edge of the clamping member opposite the side having latch 125a. The rotation shaft may be snapped into hinge receptors 127 which are integrally formed with the base 122e′ of rack 122′. Once attached to the rack 122′, the clamping member pivots in a manner similar to that described previously. In an alternative embodiment, a single U-shaped clamping member may be hingedly attached to one side of the base of the rack. This U-shaped clamping member may be closed after the desired number of communication cables have been installed into the rack by swinging the free leg of the clamping member over the rack and clipping it to the other side of the base opposite the hinge. In yet another alternative embodiment of the retention device, the clamping members may be separate clips having a latch along two opposite sides that encage with catches located on the top shelf and the base of the rack. Alternatively, a single U-shaped clamping member may be fitted over the rack and secured by latches to the base of the rack by clips or latches.

Referring to FIGS. 3A-C, cable retention device 220 includes a rack 222 for securing a plurality of telecommunication cables to the inlet device and a tongue 221 extending from the backside of the rack 222 to secure the retention device 220 in to the housing of an inlet device as described previously. Retention device 220 has a base 222e and a crown 222c with two side walls 222d that extend generally perpendicular from the base 222e to the crown 222c. In an exemplary embodiment, a plurality of fiber optic drop cables, such as FRP drop cables may be fitted into a corresponding number of compartments 222a within the rack 222 of retention device 220. In the embodiment shown in FIGS. 3A and 3B, there are three compartments 222a adjacent to the base 222e and three more compartments 222a adjacent to the crown 222c. Each compartment 222a may be separated from an adjacent compartment next to it by a partition 222b. Each partition 222b can have a plurality of ridges or teeth 222f located on one or both surfaces of each partition. The teeth 222f can engage with the outer sheath of the telecommunication cable to hold it firmly within a given compartment against an axial load placed on the cable.

Additionally, the retention device may have a pressure wedge 228 to assist in retaining the cables within their respective compartments. Pressure wedge 228 can be inserted into the front end of the rack 222 between the compartments 222a adjacent to the crown 222c and the compartments 222a adjacent to the base 222e after the telecommunication cables have been inserted into rack 222. The pressure wedge 228 is inserted until wings 228a meet the stops 222g on rack 222. The pressure wedge 228 has a tapered front end to facilitate insertion of the pressure wedge into rack 222. FIGS. 3A and 3B show a pair of clamping members 225 that lock the pressure wedge 228 in rack 222 when the latches 225a on each clamping member engage with cantilevered hooks 228b on the pressure wedge.

FIGS. 3B and 3C show a clamping member 225 and the rack 222 of retention device 220 of FIG. 3A, respectively. The inside surface of clamping member 225 is shown in FIG. 3B. The clamping member 225 has a recess 225b to accommodate the wings 228a of the pressure wedge 228, shown in FIG. 3A, when the clamping members are closed to secure the pressure wedge in the rack of retention device. The clamping member 225 may be pivotally attached to rack 222 by inserting bosses 225c on the clamping members into cavities 222h in the rack.

The telecommunication cables may be inserted through rack 222 and positioned in compartments 222a. FIG. 3D shows a cross-section of rack 222 including telecommunication cables 50 positioned in compartments 222a. Once the desired number of telecommunication cables have been installed in the rack, the pressure wedge 228 is inserted into the front end of the rack 222 in an insertion direction 228d between the compartments 222a adjacent to the crown 222c and the compartments 222a adjacent to the base 222e as shown in FIG. 3E. FIG. 3F shows the closing of the clamping members in a direction 225d to secure the pressure wedge in rack 222. The latch 225a on the clamping member 225 engages with the cantilevered hook 228b on the pressure wedge to lock the wedge in rack 222. FIG. 3G shows an exemplary embodiment of an assembled retention device 220 having six telecommunication cables 50 installed therein. While the embodiment shown in FIG. 3G shows a retention device with six cables, the retention device may be designed to hold any number of cables from one up to the number of compartments in the rack of the retention device. In addition, the retention device may be designed with either more or less compartments than are shown in the figures depending on the size and shape of the cables to be held and the size of the port in a telecommunication enclosure into which the inlet device is to be installed. Thus, the embodiments in the figures should not be construed as limiting.

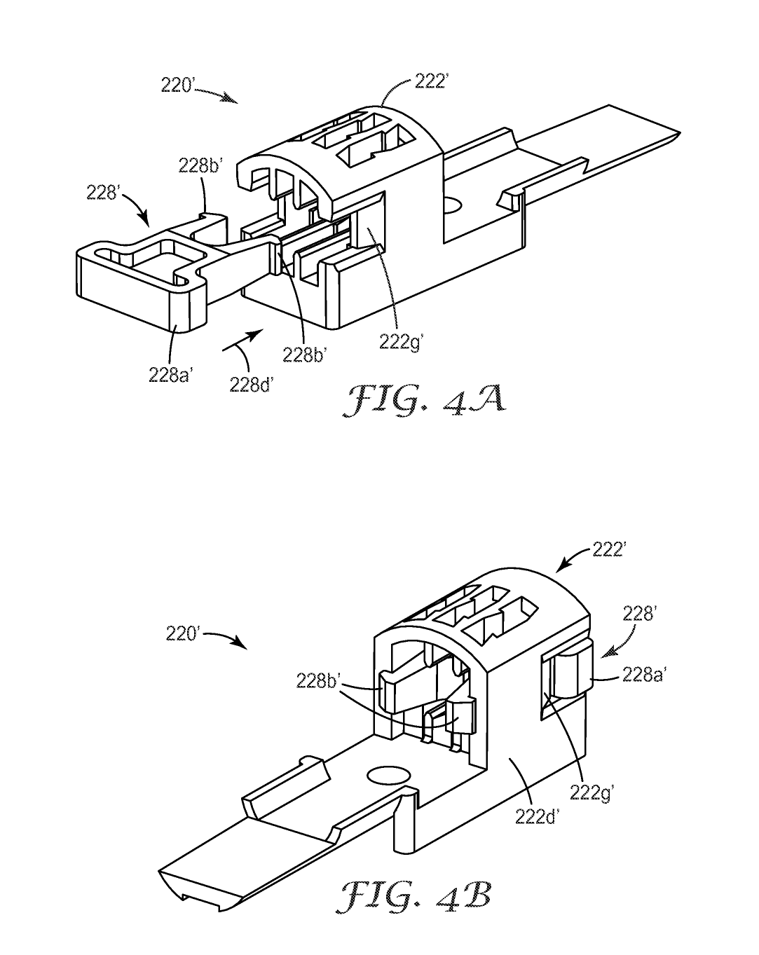

FIGS. 4A and 4B show an alternative embodiment of a cable retention device 220′ having a pressure wedge 228′. Pressure wedge 228′ has a pair of hooks 228b′ formed at the tapered front end 228c of the pressure wedge. The pressure wedge 228′ can be inserted into the front side of rack 222′ in a direction 228d′ until the wings 228a′ of the pressure wedge contact the stops 222g′ of rack 222′. The hooks 228b′ can engage with the side walls 222d′ of retention device 220′ to secure pressure wedge 228′ into the rack 222′. To release the pressure wedge 228′, the hooks may be pressed inwards and the pressure wedge may be extracted from rack 222′ by pulling it in a direction opposite the insertion direction 228d′.

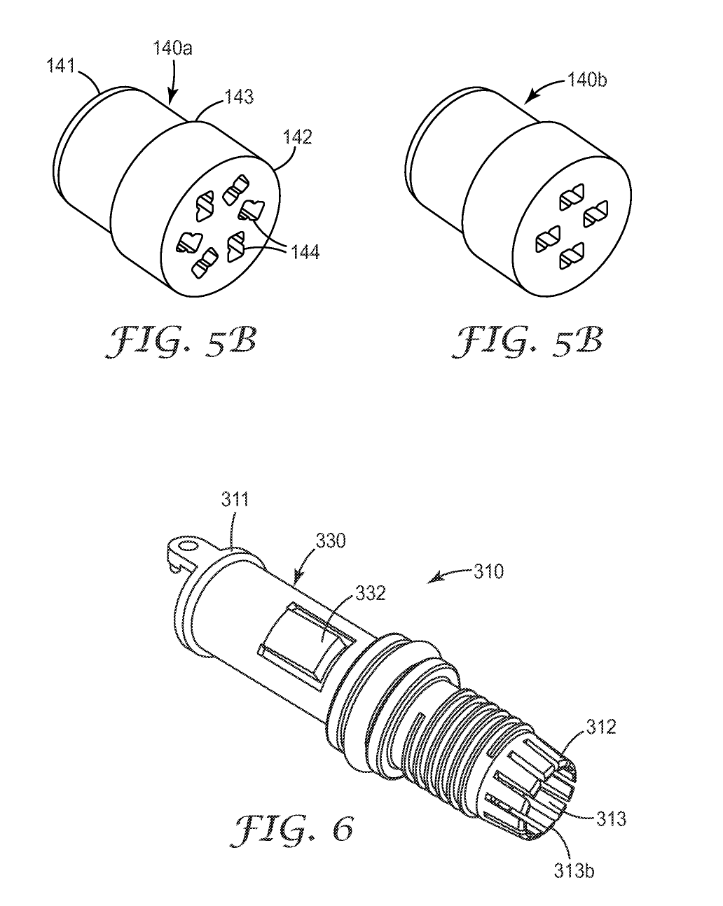

FIGS. 5A and 5B show two exemplary embodiments of internal sealing members 140a, 140b which are insertable in the second end of the housing in the exemplary inlet device described herein. FIG. 5A shows an internal sealing member 140A capable of accommodating six FRP drop cables and FIG. 5B shows and internal sealing member 140b capable of accommodating four FRP drop cables.

The details of an exemplary internal sealing member 140a will be described with respect to FIG. 5A. Internal sealing member 140a has six openings 144 passing from a first end 141 to a second end 142 to accommodate insertion of up to six drop cables (not shown) therethrough. The internal sealing member 140a can have a first diameter at the first end 141 of the internal sealing member, a second diameter at the second end 142 of the internal sealing member, and a step transition 143 between the first and second ends. The first diameter can be smaller than the second diameter, such that the first end 141 of the internal sealing member may be inserted into the interior passage way of the inlet device's housing. The larger second diameter may be accommodated within the compressible portion of the housing. The step transition 143 can prevent the internal sealing member from slipping too far inside of the housing when the clamping nut is applied to the second end of the housing to compress the compressible portion of the housing around the internal sealing member 140a. The size and shape of the openings may be altered to accommodate other types of optical fiber drop cables such as flat drop cables and round drop cables. In one exemplary embodiment, it may be desirable to install an exemplary inlet device with an internal sealing member having some number of opening running through the internal sealing member, but install some number of cables that is less than the number of openings in the internal sealing member. In this case a blank pug (not shown) can be inserted into any of the openings in the internal sealing member not filled with a telecommunication cable. This allows for the addition of adding additional drop cables when additional service connections are needed while maintaining the environmental sealing of the inlet device. In an alternative, the internal sealing member may be formed having a thin web (not show) of material blocking the openings at one end of the sealing member. In this embodiment, the craftsman may puncture the thin web in the openings in which cables are to be installed. If fewer cables are inserted through the internal sealing member than the number of available openings, the thin web will ensure the environmental sealing of the inlet device.

FIG. 6 shows an alternative embodiment of a housing 310 having a first end 311 and a second end 312. The housing 310 may be generally cylindrical in shape and includes an interior passageway 313 that extends along the length of the housing 310 from the first end 311 to the second end 312 of the housing. Housing 310 includes a passage exit 313b at the second end 312 of the interior passageway 313 that may be configured to accommodate certain categories of telecommunication cables including single fiber drop cables and multi-fiber cables and a passage entry (not shown) to accommodate a retention device as described previously.

Housing 310 can have a securing zone 330 adjacent to the first end 311 of the housing. The securing zone 330 may include a pair of locking elements 332 which protrude from opposite sides of the housing 310. In an exemplary housing 310, the locking elements 332 may have a deformable cantilever structure which can flex when depressed to allow the inlet device to be removed from a close fitting port of a telecommunication enclosure. This housing configuration is described more fully in U.S. Patent Application No. 61/043,652, which is incorporated by reference herein, in its entirety.

The inlet device embodiments described above provide a simple and user-friendly design thereby greatly facilitating the installation of the last leg of the FTTH network to the end user.

Various modifications including extending the use of the inlet device to applications with copper telecommunication cables or copper coax cables, equivalent processes, as well as numerous structures to which the present invention may be applicable will be readily apparent to those of skill in the art to which the present invention is directed upon review of the present specification.

1. An inlet device, the inlet device comprising:
a housing having a first end and a second end, wherein the housing includes a compressible portion at the second end of the housing
a cable retention device attachable to the first end of the housing wherein the retention device includes a support rack to discretely hold a plurality of communication cables; and
a compression member attachable over the compressible portion of the housing.

2. The inlet device of claim 1, further comprising a pressure wedge to assist in holding and retaining of the plurality of communication cables in the rack of the retention device.

3. The inlet device of claim 2, further comprising a clamping member to secure the pressure wedge in the retention device.

4. The inlet device of claim 1, further comprising at least one clamping member to secure the communications cables in the retention device.

5. The inlet device of claim 4, wherein the at least one clamping member is pivotally connected to the rack of the retention device.

6. The inlet device of claim 1, further comprising an internal sealing member fitted into the second end of the housing, wherein the plurality of cables pass through the internal sealing member and wherein the internal sealing member may be squeezed by the compressible portion of the housing when the compression member is attached to the second end of the housing.

7. The inlet device of claim 6, wherein the internal sealing member has a plurality of openings extending from a first end on the internal sealing member to the second end of the internal sealing member and wherein each opening accommodates the passage of one telecommunication cable therethrough.

8. The inlet device of claim 1 wherein the rack has a plurality compartments to hold the plurality of communication cables.

9. The inlet device of claim 8, further comprising a shelf to separate adjacent compartments, wherein each shelf has a plurality of teeth disposed on a surface of the shelf and wherein the teeth bite into a jacket of a telecommunication cable installed in the compartment adjacent to the shelf.
